(19) United States
(12) Patent Application Publication
(10) Pub. No.: US 2005/0080813 A1
(43) Pub. Date: Apr. 14, 2005

(54) Methods and apparatus to analyze escape analysis of an application

(76) Inventors: Xiaohua Shi, Beijing (CN); Gansha Wu, Beijing (CN); Guei-Yuan Lueh, San Jose, CA (US); Yun Zhang, Toronto (CA)

Correspondence Address: GROSSMAN & FLIGHT LLC, Suite 4220, 20 North Wacker Drive, Chicago, IL, 60606-6357, US

(21) Appl. No.: 10/684,690

(22) Filed: Oct. 14, 2003

(51) Int. Cl. G06F 7/00

(52) U.S. Cl. 707/103 R

(57) ABSTRACT

Methods and apparatus to analyze escape analysis of an application are described herein. In an example method, one or more methods associated with a violating condition of the application are identified. The one or more methods are parsed into at least one equivalence class. A first escape indicator and a second escape indicator associated with each of the at least one class are identified. Based on the first and second escape indicators, the one or more methods are propagated.

### TECHNICAL FIELD

The present disclosure relates generally to compilers, and more particularly, to methods and apparatus to analyze escape analysis of an application.

### BACKGROUND

The Java programming language provides concurrent-programming support at the language level that allows multiple threads to access shared data by synchronizing methods and blocks. In multiple processor systems, synchronization typically relies on a lock instruction to ensure that the processor executing the lock instruction has exclusive use of any shared memory and/or other data structures. However, such synchronization operations usually impose considerable overhead for server applications. In fact, some synchronization operations are unnecessary. For example, synchronization is not needed when a method is reachable only by a single thread and concurrent access is not possible.

Escape analysis is a technique that eliminates unnecessary synchronization operations. In particular, an object may escape the method that created the object (i.e., the object is not local to the method). Alternatively, the object may escape the thread that created the object (i.e., other threads may access the object). Further, escape analysis may also guide allocation of stack objects, which creates Java objects on the stack rather than on the heap (i.e., an area of the main memory that a program may use to store data in a varying amount known only when the program is running).

Most escape analyses operate in a closed environment in which a compiler statically determines all methods that may be executed by a program. In particular, the compiler determines the side effects at procedural boundaries and applies optimizations with the full knowledge of the entire program. When Java programs run on a Java virtual machine, however, there are many open environment features that may cause the compiler to malfunction. That is, open environment features such as dynamic class loading, native method(s), and/or reflection violates the assumptions associated with a closed environment.

### BRIEF DESCRIPTION OF THE DRAWINGS

FIG. 1 is a block diagram representation of an example processor system.

FIG. 2 is a block diagram representation of an example escape analysis analyzing system.

FIG. 3 is a block diagram representation of an example call graph including an escape status flag.

FIG. 4 is a block diagram representation of an example call graph including two escape status flags.

FIG. 5 is a flow diagram representation of example machine readable instructions that may analyze escape analysis of an application.

### DETAILED DESCRIPTION

Although the following discloses example systems including, among other components, software or firmware executed on hardware, it should be noted that such systems are merely illustrative and should not be considered as limiting. For example, it is contemplated that any or all of the disclosed hardware, software, and/or firmware components could be embodied exclusively in hardware, exclusively in software, exclusively in firmware or in some combination of hardware, software, and/or firmware.

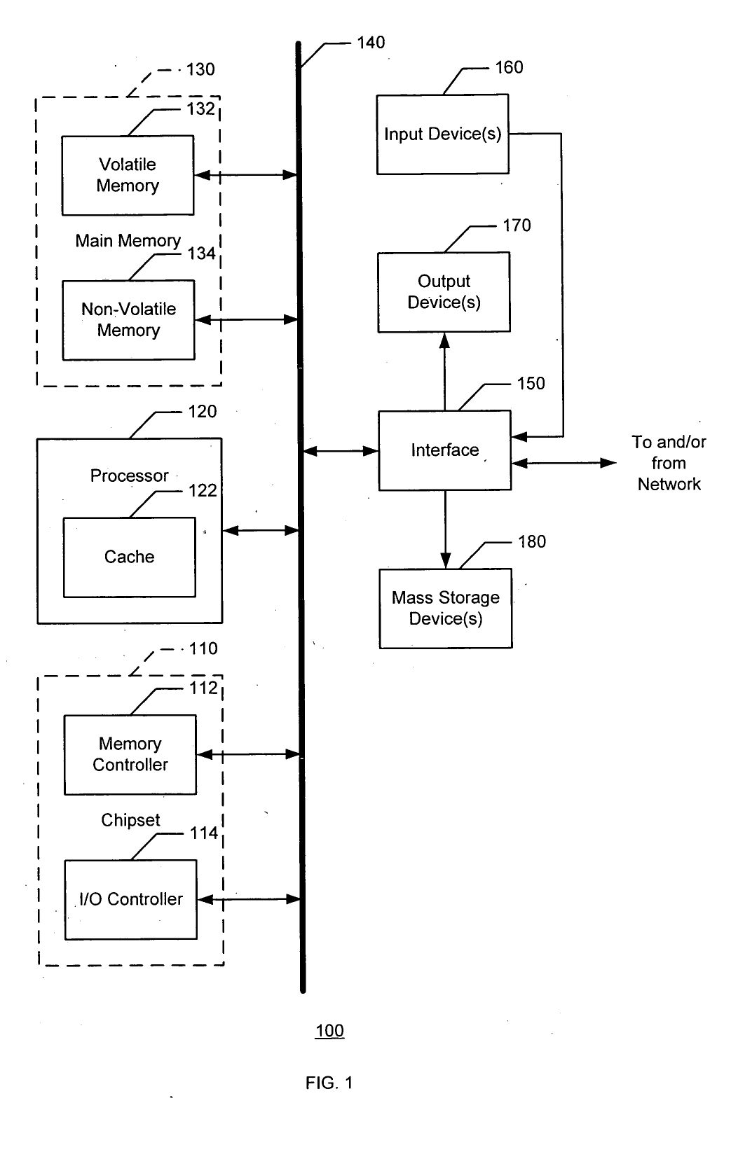

FIG. 1 is a block diagram of an example processor system 100 adapted to implement the methods and apparatus disclosed herein. The processor system 100 may be a desktop computer, a laptop computer, a notebook computer, a personal digital assistant (PDA), a server, an Internet appliance or any other type of computing device.

The processor system 100 illustrated in FIG. 1 includes a chipset 110, which includes a memory controller 112 and an input/output (I/O) controller 114. As is well known, a chipset typically provides memory and I/O management functions, as well as a plurality of general purpose and/or special purpose registers, timers, etc. that are accessible or used by a processor 120. The processor 120 is implemented using one or more processors. For example, the processor 120 may be implemented using one or more of the Intel® Pentium® family of microprocessors, the Intel® Itanium® family of microprocessors, Intel® Centrino® family of microprocessors, and/or the Intel XScale® family of processors. In the alternative, other processors or families of processors may be used to implement the processor 120.

As is conventional, the memory controller 112 performs functions that enable the processor 120 to access and communicate with a main memory 130 including a volatile memory 132 and a non-volatile memory 134 via a bus 140. The volatile memory 132 may be implemented by Synchronous Dynamic Random Access Memory (SDRAM), Dynamic Random Access Memory (DRAM), RAMBUS Dynamic Random Access Memory (RDRAM), and/or any other type of random access memory device. The non-volatile memory 134 may be implemented using flash memory, Read Only Memory (ROM), Electrically Erasable Programmable Read Only Memory (EEPROM), and/or any other desired type of memory device.

The processor system 100 also includes an interface circuit 150 that is coupled to the bus 140. The interface circuit 150 may be implemented using any type of well known interface standard such as an Ethernet interface, a universal serial bus (USB), a third generation input/output interface (3GIO) interface, and/or any other suitable type of interface.

One or more input devices 160 are connected to the interface circuit 150. The input device(s) 160 permit a user to enter data and commands into the processor 120. For example, the input device(s) 160 may be implemented by a keyboard, a mouse, a touch-sensitive display, a track pad, a track ball, an isopoint, and/or a voice recognition system.

One or more output devices 170 are also connected to the interface circuit 150. For example, the output device(s) 170 may be implemented by display devices (e.g., a light emitting display (LED), a liquid crystal display (LCD), a cathode ray tube (CRT) display, a printer and/or speakers). The interface circuit 150, typically includes, among other things, a graphics driver card.

The processor system 100 also includes one or more mass storage devices 180 configured to store software and data. Examples of such mass storage device(s) 180 include floppy disks and drives, hard disk drives, compact disks and drives, and digital versatile disks (DVD) and drives.

The interface circuit 150 also includes a communication device such as a modem or a network interface card to facilitate exchange of data with external computers via a network. The communication link between the processor system 100 and the network may be any type of network connection such as an Ethernet connection, a digital subscriber line (DSL), a telephone line, a cellular telephone system, a coaxial cable, etc.

Access to the input device(s) 160, the output device(s) 170, the mass storage device(s) 180 and/or the network is typically controlled by the I/O controller 114 in a conventional manner. In particular, the I/O controller 114 performs functions that enable the processor 120 to communicate with the input device(s) 160, the output device(s) 170, the mass storage device(s) 180 and/or the network via the bus 140 and the interface circuit 150.

While the components shown in FIG. 1 are depicted as separate functional blocks within the processor system 100, the functions performed by some of these blocks may be integrated within a single semiconductor circuit or may be implemented using two or more separate integrated circuits. For example, although the memory controller 112 and the I/O controller 114 are depicted as separate functional blocks within the chipset 110, persons of ordinary skill in the art will readily appreciate that the memory controller 112 and the I/O controller 114 may be integrated within a single semiconductor circuit.

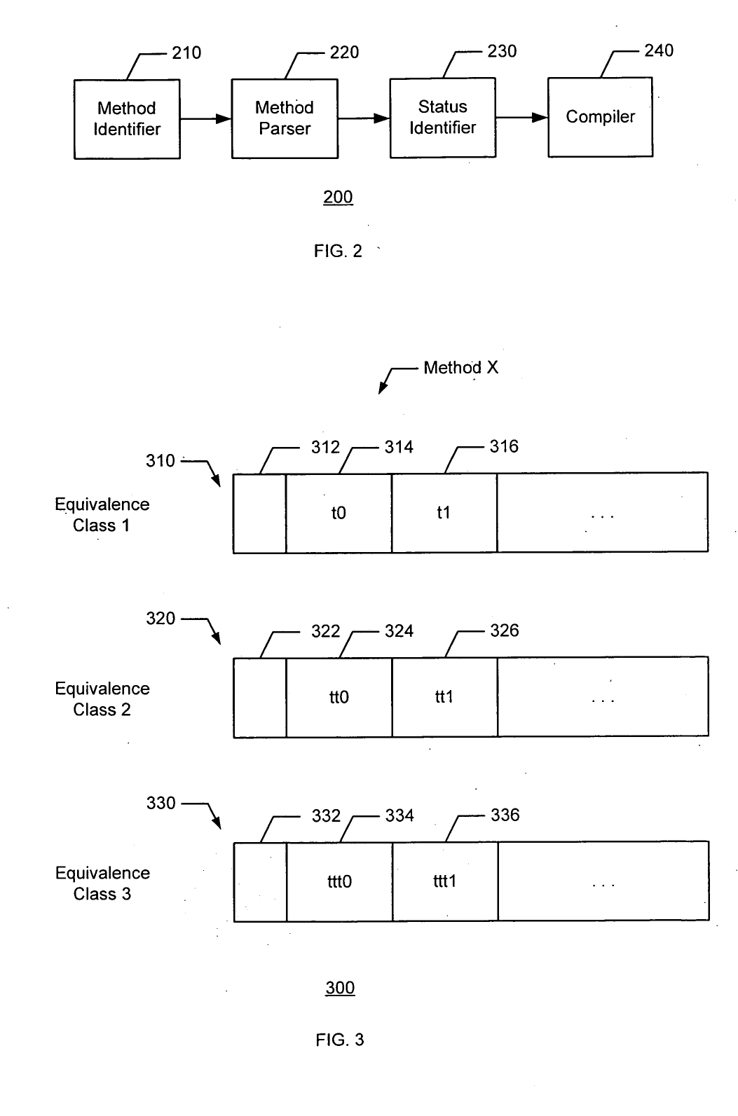

In the example of FIG. 2, the illustrated escape analysis analyzing system 200 includes a method identifier 210, a method parser 220, a status identifier 230, and a compiler 240. The escape analysis analyzing system 200 may be implemented by the processor 120 of the processor system 100 shown in FIG. 1 to analyze escape analysis of an application. In general, the method identifier 210 is configured to identify one or more methods associated with a violating condition of an application. In particular, the method identifier 210 may identify one or more methods associated with dynamic class loading, native methods, and/or reflection. As used herein the term “method” refers to one or more functions, routines, or subroutines for manipulating data. Persons of ordinary skill in the art will readily recognize that a method is defined as part of a class and is included in any object of that class. A class is a template definition of the methods and variables composing a particular kind of object. Accordingly, an object is a specific instance of a class that contains real values instead of variables.

As noted above, one or more methods associated with a violating condition of the application includes one or more methods associated with dynamic class loading, native method(s), and/or reflection. In particular, a method is associated with dynamic class loading when an application includes one or more classes that can be inserted into the application. While each of the dynamically loadable classes is distinct and independent, all of these classes share a similar interface. In other words, the classes have some methods in common, and the method identifier 210 identifies those methods. Persons of ordinary skill in the art will readily recognize that a method is associated with native method(s) when the method is compiled to run with a particular processor and its sets of instructions, and reflection may be an instance when a method and/or a field is reflected to different entities that is determined during runtime of the application.

The method parser 220 is configured to parse the methods identified by the method identifier 210 into at least one equivalence class. As described in detail below, each equivalence class includes an escape status flag and a set of variables that are equivalent to each other. The status identifier 230 is configured to identify a first status indicator and a second status indicator associated with each of the at least one equivalence class. For example, the status identifier 230 may identify a bottom-up escape status flag and a top-down escape status flag. Based on the first and second status indicators, the compiler 240 propagates the methods identified by the method identifier 210. For example, the compiler 240 may be a just-in-time (JIT) compiler of a Java virtual machine (JVM), which interprets compiled Java binary code (i.e., bytecode) for the hardware platform of the processor system 100 (i.e., the processor 120) to execute the instructions of a Java application. In particular, the JIT compiler is a program that converts the bytecode into instructions that may be sent directly to the processor 120. Further, the compiler 240 may update the escape analysis of the application to optimize performance of the application.

Typically, a call graph of an application (e.g., a Java application) is constructed and traversed in two propagation passes to perform escape analysis. In the example of FIG. 3, Method X is parsed into a set of equivalence classes 300, generally shown as Equivalence Class 1, Equivalence Class 2, and Equivalence Class 3, indicated at reference numerals 310, 320, and 330, respectively. Each equivalence class includes an escape status flag, generally shown as 312, 322, and 332. Further, each equivalence class includes a set of variables that are equivalent to each other. In Equivalence Class 1 310, for example, variable t0 314 and variable t1 316 are equivalent. Accordingly, variable tt0 324 and variable tt1 326 in Equivalence Class 2 320 are equivalent, and variable ttt0 334 and variable ttt1 336 in Equivalence Class 3 330 are equivalent.

Persons of ordinary skill in the art will readily recognize that escape analysis propagates the escape status between caller methods and callee methods. For example, method A may call method B with arguments a0 and a1 (i.e., A calls B as B(a0, a1)), and method may include formal arguments t0 and t1 (i.e., B is declared as B(t0, t1)). The escape status of the equivalence class including variable t0 in method B may be propagated to the equivalence class including variable a0 in method A in a bottom-up propagation. Alternatively, the escape status of the equivalence class including variable a0 in method A may be propagated to the equivalence class including variable t0 in method B in a top-down propagation. Likewise, the escape status of the equivalence class including variable t1 in method B may be propagated to the equivalence class including variable a1 in method A in a bottom-up propagation, and the escape status of the equivalence class including variable a1 in method may be propagated to the equivalence class including variable t1 in method B in a top-down propagation.

On the first pass, the escape analysis traverses the call graph in a bottom-up topological order. That is, the escape analysis propagates the escape status flag of every equivalence classes 300 from callee methods to caller methods via arguments and return values when the equivalence class 300 indicates a set of reference variables that share the same escape status (i.e., t0 314 and t1 316, tt0 324 and tt1 326, and/or ttt0 334 and ttt1 336). On the second pass, the escape analysis propagates the escape status from caller methods to callee methods in a top-down topological order. The two passes propagate the same escape status for each of the equivalent classes 300.

However, using only a single flag in both propagation passes may not be adequate to re-analyze the escape status of the equivalent classes 300. Without distinguishing the escape status for the bottom-up propagation (i.e., callee methods to caller methods) and the top-down propagation (i.e., caller methods to callee methods), the escape status of the actual arguments of the caller methods may be propagated into the equivalence class of the corresponding argument of the callee methods. To re-analyze the call graph at runtime, both the bottom-up propagation and the top-down propagation are re-run. Accordingly, the escape status of a caller method propagated down to a callee method during the prior top-down propagation is now propagated bottom-up to all the caller methods of the callee method. That is, the escape status of a caller method influences other caller methods, and the mutually exclusive caller methods are interacting with each other. As a result of re-running the bottom-up propagation and the top-down propagation, the precision of the result from the escape analysis is deteriorated because non-escape reference variables may escape during the re-run of the bottom-up and the top-down propagations.

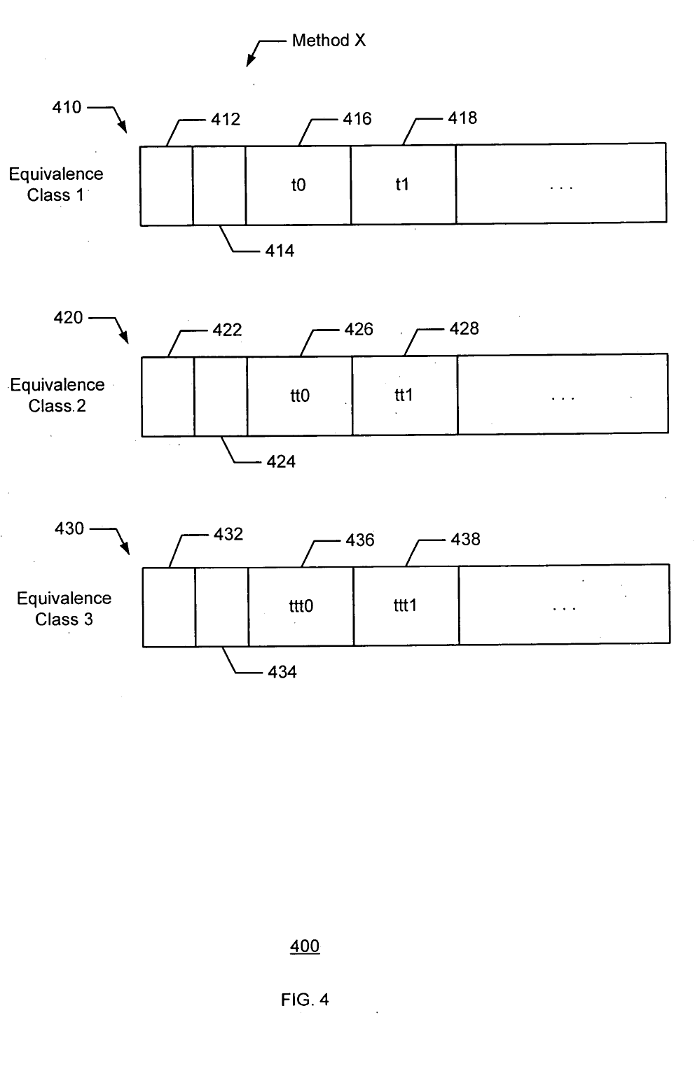

To support analysis of the escape analysis without degrading precision, two escape status flags associated with each equivalence class are used. In the example of FIG. 4, each of the illustrated equivalence classes 400 includes two escape status flags (i.e., an up status flag and a down status flag), whereas each of the equivalence classes 300 includes a single escape flag. In particular, Equivalence Class 1 410 includes an up status flag 412 and a down status flag 414, Equivalence Class 2 420 includes an up status flag 422 and a down status flag 424, and Equivalence Class 3 430 includes an up status flag 432 and a down status flag 434. The bottom-up pass propagates the up status flag(s) 412, 422, and 432, while the top-down pass propagates the down status flag(s) 414, 424, and 434 with the initial value of the up status flag(s) 412, 422, and 432. The down status flag of an equivalence class indicates the final result of the escape analysis for that particular equivalence class.

As noted above, the method identifier 210 identifies one or more methods associated with a violating condition into a working set. For example, method X is added to the working set if method X is introduced into an application by dynamic class loading (i.e., when an application includes a lot of classes that can be inserted into the application, and each class is distinct and independent, but all of the classes share a similar interface such as one or more common methods). For an existing method, if the caller set of the existing method is changed (i.e., reflection), then the existing method is added to the working set. That is, one or more caller methods are added to the caller set of the existing method. For example, if method X is an existing method and its caller set is changed (i.e., more caller methods are added to the caller set of method X), then method X is added into the working set. For any recursive calls (e.g., method X calling itself), all the methods in a recursive call chain are added into the working set if the recursive call chain changes because the newly added methods may affect the escape status of all the methods within the recursive call chain. That is, the recursive call chain changes when one or more methods are added to the recursive call chain. The recursive call chain also changes when recursive call chains are merged together after dynamic class loading.

The analysis of escape analysis propagates an escape status of up (i.e., up status flags 412, 422, and 432) from every method in the working set to its caller method(s) in a bottom-up topological order. During the propagation, a method is also added into the working set if the escape status of the method changes. The loop continues until all the methods in the working set have been processed.

The analysis of escape analysis propagates an escape status of down (i.e., down status flags 414, 424, and 434) from every method in the working set to its callee method(s) in a top-down topological order. Before the propagation, each of the down status flags 414, 424, and 434 is initialized to the value of the up status flags 412, 422, and 432, respectively. During the propagation, if the escape status of a callee method is changed, the callee method is added into the working set. The loop terminates when all the methods in the working have been processed.

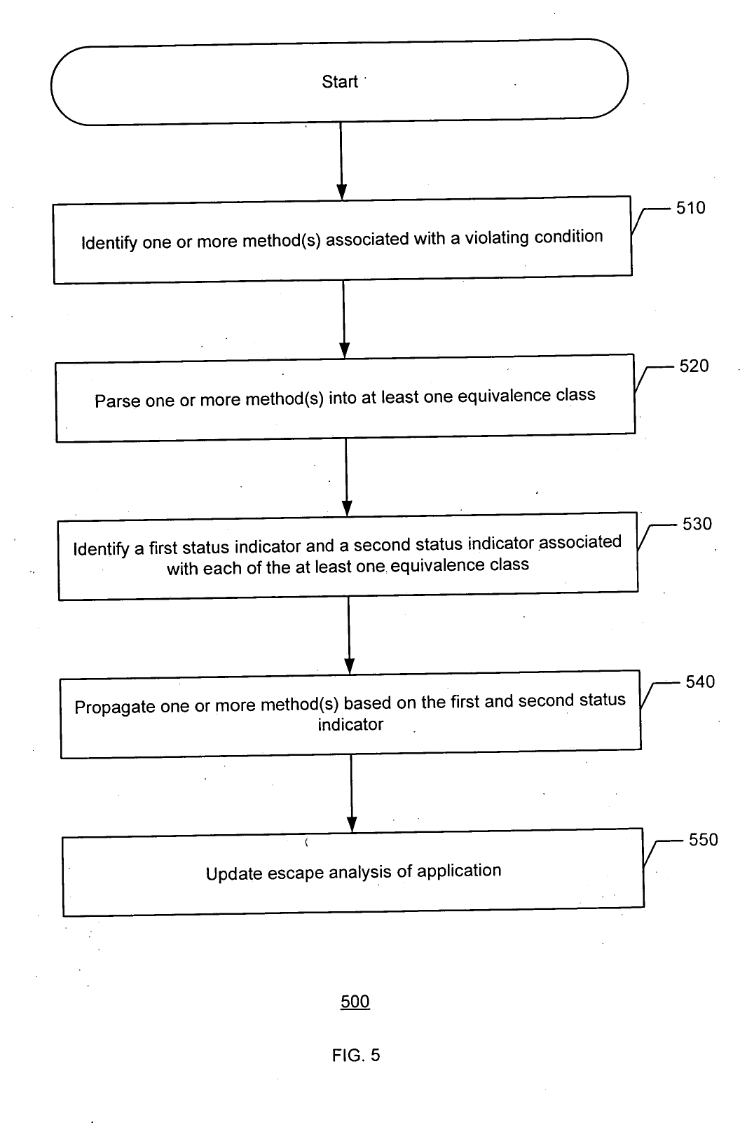

Machine readable instructions that may be executed by the processor system 100 (e.g., via the processor 120) are illustrated in FIG. 5. Persons of ordinary skill in the art will appreciate that the instructions can be implemented in any of many different ways utilizing any of many different programming codes stored on any of many computer-readable mediums such as a volatile or nonvolatile memory or other mass storage device (e.g., a floppy disk, a CD, and a DVD). For example, the machine readable instructions may be embodied in a machine-readable medium such as a programmable gate array, an application specific integrated circuit (ASIC), an erasable programmable read only memory (EPROM), a read only memory (ROM), a random access memory (RAM), a magnetic media, an optical media, and/or any other suitable type of medium. Further, although a particular order of steps is illustrated in FIG. 5, persons of ordinary skill in the art will appreciate that these steps can be performed in other temporal sequences. Again, the flow chart 500 is merely provided as an example of one way to program the processor system 100 to analyze escape analysis of an application.

In the example of FIG. 5, the processor system 100 (e.g., via the processor 120) identifies one or more methods associated with a violating condition of an application (block 510). During runtime of a Java application, for example, the processor 120 identifies one or more methods associated with dynamic class loading into a working set. The working set may include a new method, an additional method, and/or a method associated with change to a recursive call chain. In another example, the processor 120 identifies one or more methods associated with native methods and/or reflection. The processor 120 parses the identified methods into at least one equivalence class (block 520). In particular, each equivalence class includes a set of variables that are equivalent. The processor 120 then identifies a first status indicator and a second status indicator associated with each equivalence class (block 530). For example, the processor 120 identifies a bottom-up escape status flag and a top-down escape status flag associated with each of the equivalence classes 400 shown in FIG. 4. Based on the first and second status indicators, the processor 120 propagates the identified methods (block 540). During propagation of the identified methods, the processor 120 may add caller method(s) associated with the identified method into the working set if the escape status of the caller method(s) is changed. The processor 120 may also add callee method(s) associated with the identified method into the working set if the escape status of the callee method(s) is changed. Further, the processor 120 updates the escape analysis of the application (block 550). As a result, the performance of the application is optimized in an open environment (i.e., when assumption of a closed environment breaks down, and the application is affected by dynamic class loading, native method(s) and/or reflection).

The methods and apparatus disclosed herein are particularly well suited for processors executing Java applications. However, persons of ordinary skill in the art will appreciate that the teachings of the disclosure may be applied to processors executing other types of applications.

Although certain example methods, apparatus, and articles of manufacture have been described herein, the scope of coverage of this patent is not limited thereto. On the contrary, this patent covers all methods, apparatus, and articles of manufacture fairly falling within the scope of the appended claims either literally or under the doctrine of equivalents.

1. A method to analyze escape analysis of an application comprising:
identifying one or more methods associated with a violating condition;
parsing the one or more methods into at least one equivalence class;
identifying a first escape indicator and a second escape indicator associated with each of the at least one equivalence class; and
propagating the one or more methods based on the first and second escape indicators.

2. A method as defined in claim 1, wherein identifying the one or more methods associated with the violating condition comprises identifying at least one of a new method, an additional method, and a method associated with a change in a recursive call chain.

3. A method as defined in claim 1, wherein identifying the one or more methods associated with the violating condition comprises identifying one or more methods associated with at least one of dynamic class loading, native method, and reflection.

4. A method as defined in claim 1, wherein identifying the one or more methods associated with the violating condition comprises identifying the one or more methods during runtime of the application.

5. A method as defined in claim 1, wherein identifying the first escape indicator and the second escape indicator associated with each of the at least one class comprises identifying a bottom-up escape status flag and a top-down escape status flag.

6. A method as defined in claim 1, further comprising updating the escape analysis of the application.

7. A machine readable medium storing instructions, which when executed, cause a machine to:
identify one or more methods associated with a violating condition;
parse the one or more methods into at least one equivalence class;
identify a first escape indicator and a second escape indicator associated with each of the at least one class; and
propagate the one or more methods based on the first and second escape indicators.

8. A machine readable medium as defined in claim 7, wherein the instructions cause the machine to identify the one or more methods associated with the violating condition by identifying at least one of a new method, an additional method, and a method associated with a change in a recursive call chain.

9. A machine readable medium as defined in claim 7, wherein the instructions cause the machine to identify the one or more methods associated with the violating condition by identifying one or more methods associated with at least one of dynamic class loading, native method, and reflection.

10. A machine readable medium as defined in claim 7, wherein the instructions cause the machine to identify the one or more methods associated with the violating condition by identifying the one or more methods during runtime of the application.

11. A machine readable medium as defined in claim 7, wherein the instructions cause the machine identify the first escape indicator and the second escape indicator associated with each of the at least one class by identifying a bottom-up escape status flag and a top-down escape status flag.

12. A machine readable medium as defined in claim 7, further comprising instructions, which when executed, cause the machine to update the escape analysis of the application.

13. A machine readable medium as defined in claim 7, wherein the machine readable medium comprises one of a programmable gate array, an application specific integrated circuit, an erasable programmable read only memory, a read only memory, random access memory, a magnetic media, and an optical media.

14. An apparatus to analyze escape analysis of an application comprising:
a method identifier configured to identify one or more methods associated with a violating condition;
a method parser coupled to the method identifier and configured to parse the one or more methods into at least one class;
a status identifier coupled to the method parser and configured to identify a first status indicator and a second status indicator associated with the least one class; and
a compiler coupled to the status identifier and configured to propagate the one or more methods based on the first and second status indicators.

15. An apparatus as defined in claim 14, wherein one or more methods associated with a violating condition comprises at least one of a new method, an additional method, and a method associated with a change in a recursive call chain.

16. An apparatus as defined in claim 14, wherein the violating condition comprises at least one of dynamic class loading, native method, and reflection.

17. An apparatus as defined in claim 14, wherein the first escape indicator comprises a bottom-up escape status flag.

18. An apparatus as defined in claim 14, wherein the second escape indicator comprises a top-down escape status flag.

19. An apparatus as defined in claim 14, wherein the compiler is configured to update the escape analysis of the application.

20. A processor system to analyze escape analysis of an application comprising:
a dynamic random access memory (DRAM) configured to store one or more methods of the application;
a processor operatively coupled to the DRAM, the processor being programmed to identify the one or more methods associated with the violating condition, to parse the one or more methods into at least one equivalence class, to identify a first escape indicator and a second escape indicator associated with each of the at least one class, and to propagate the one or more methods based on the first and second escape indicators.

21. A processor system as defined in claim 20, wherein the one or more methods associated with a violating condition comprises at least one of a new method, an additional method, and a method associated with a change in a recursive call chain.

22. A processor system as defined in claim 20, wherein the violating condition comprises at least one of dynamic class loading, native method, and reflection.

23. A processor system as defined in claim 20, wherein the first escape indicator comprises a bottom-up escape status flag.

24. A processor system as defined in claim 20, wherein the second escape indicator comprises a top-down escape status flag.

25. A processor system as defined in claim 20, wherein the processor is configured to update the escape analysis of the application.
